(19) United States
(12) Patent Application Publication
(10) Pub. No.: US 2004/0044637 A1
(43) Pub. Date: Mar. 4, 2004

(54) Apparatus and method using reflection to generate database commands at runtime

(76) Inventors: Thomas Vachuska, Roseville, CA (US); Eric Hubbard, Roseville, CA (US)

Correspondence Address: HEWLET-PACKARD COMPANY, Intellectual Property Administration, P.O. Box 272400, Fort Collins, CO, 80527-2400, US

(21) Appl. No.: 10/231,693

(22) Filed: Aug. 30, 2002

(51) Int. Cl. G06F 7/00

(52) U.S. Cl. 707/1

(57) ABSTRACT

A database commands generator for a persistent object management system. An application implementing the persistent object management system includes a core system and a model for manipulating member variable objects residing on a database. The application operates in a runtime phase. The model interacts with the core system using a reflection mechanism. The core system interacts with the database manipulation mechanism for generating a plurality of database commands.

### FIELD OF THE INVENTION

The present invention relates to object management and, in particular, to apparatus and methods for generating SQL commands at runtime, for persistent object management using a database.

### BACKGROUND OF THE INVENTION

Objects, implemented in an object oriented programming environment, provide a convenient way to hold data and the associated object manipulation methods. Conventionally, object oriented environments (OOE) have focused on providing features such as inheritance, polymorphism, and code reusability. Objects being transient in nature, the thrust of these features has been on object manipulation during the life of a program. For example, objects are routinely initialized at instantiation stage and destroyed when not required. Typical OOEs lack the facilities to manage persistent objects which survive after the program execution is over.

Object oriented databases (OOD) provide a way to implement persistent objects. A typical OOD stores the whole object, i.e., the data and methods in the database. OODs are external tools which need to be interfaced to application programs. Thus, OODs inevitably increase processing overheads. Another approach involves writing custom persistency management routines for each class based on the definition of individual classes. The complexity of such an approach will rapidly increase in proportion to the number of persistent classes. Hence, there is a need for generic tools for efficient, relatively simple, and low overhead maintenance and manipulation of persistent object.

Object oriented paradigm emphasizes information hiding, and interactions between objects occur within a well-defined framework. Tools that provide generic persistency support need to know the structure of the object in order to store and manipulate it. Reflection mechanism makes it possible to examine the structure of the object. Reflection mechanism by itself does not make object persistency possible. Thus, there exists a need to implement a layer of functionality above the level of reflection mechanism to provide persistency management for OOEs.

SQL (Structured Query Language) based relational databases are widely used and are relatively easy to operate data management environments. Typical SQL tables are matrix type with data organized in rows and columns. Conventional SQL environments do not contain any native features to support object persistency. A typical OOE does not provide facilities to store its objects in a SQL database. Thus, there exists a need to provide persistency support for object oriented environments using SQL databases.

Aggregate relationships facilitate modeling of complex and highly abstract data structures. There exists a further need to provide persistency management features for aggregate relationships among various objects.

### SUMMARY OF THE INVENTION

A database commands generator for a persistent object management system. An application implementing the persistent object management system includes a core system and a model for manipulating member variable objects residing on a database. The application operates in a runtime phase. The core system includes a relationship catalogue, which is connected to the database with a communication link. The model interacts with the core system using a reflection mechanism. The core system interacts with the database manipulation mechanism for generating a plurality of database commands. In an embodiment the database commands are SQL (Structured Query Language) statements.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a system in accordance with the invention;

FIG. 2 is a schematic showing scalar relationships;

FIG. 3 is a schematic showing strong aggregate relationships;

FIG. 4 is a schematic showing weak aggregate relationships;

FIG. 5 is a block diagram of an embodiment of the invention;

FIG. 6 is a block diagram for runtime SQL generation in an embodiment of the invention;

FIG. 7 is a flow-chart for the first pass processing in an embodiment of the invention;

FIG. 8 is a flow-chart for the second pass processing; and

FIG. 9 is a flow-chart for the third pass processing.

### DETAILED DESCRIPTION OF THE PREFERRED EMBODIMENTS

The following description of the preferred embodiment(s) is merely exemplary in nature and is in no way intended to limit the invention, its application, or uses. The principles of the invention will be described in an exemplary object management system. Those skilled in the art will appreciate that other embodiments are also possible.

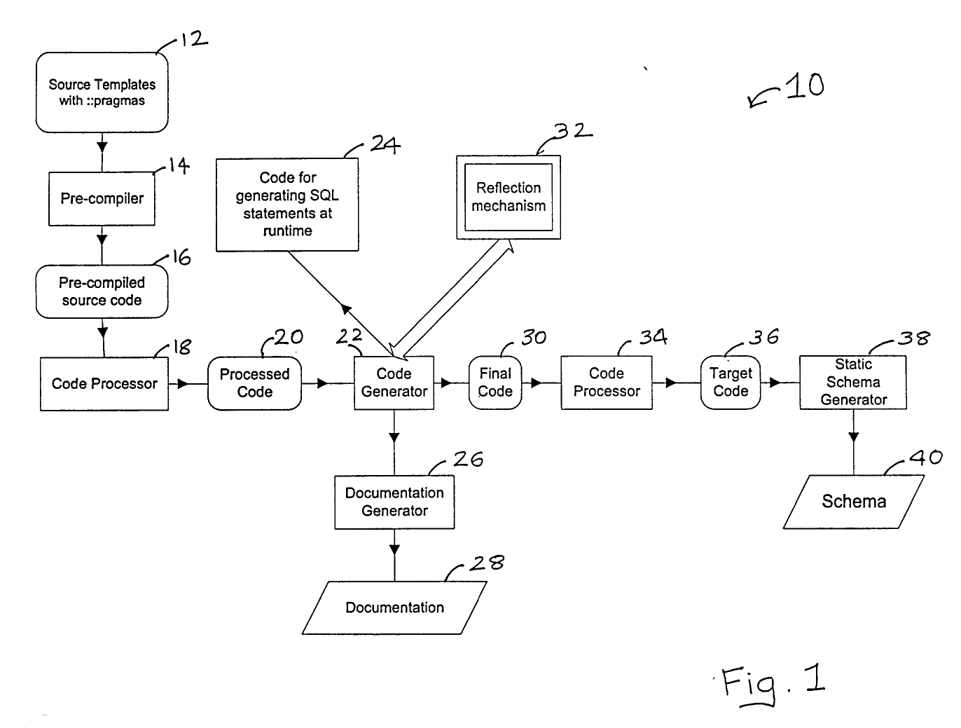

Referring to FIG. 1, the object management system 10 requires source templates 12 as an input. The source templates 12 contain pre-described patterns which include member variables defined within a protected scope. The member variables can be of either a primitive data type, descendent of a standard base class, or a collection of standard base class objects. The source templates 12 also contain source code, e.g., constructors specifying a preferred way of producing the model objects. The source templates 12 further include directives in the form of pragmas. The pragmas present in the source templates 12 are distinguished from the source code by a prefix ‘::’ or any other suitable distinguishing token.

A pre-compiler 14 receives the source templates 12 as an input. The pre-compiler 14 processes the source templates 12 into pre-compiled source code 16. A code processor 18 processes the pre-compiled source code 16 into processed code 20. A code generator 22 uses the processed code 20 to generate additional source codes which include SQL (structured query language) statements 24. The code generator 22 also generates input for a documentation generator 26 which creates the documentation 28.

The code generator 22 utilizes a reflection mechanism 32 to introspect into the class structures present in the processed code 20. The code generator 22 then generates final code 30. The code processor 34 reads the final code 30 and generates a target code 36. A static schema generator 38 analyzes the target code 36 to generate a schema 40. The schema 40 contains schema in the form of an SQL schema and is static in nature.

The system 10 operates to provide an object management system which supports random access, fast operation, and is scalable to a large number of objects. The system 10 further operates to provide transactions restricted within a user-defined scope; extensibility by using arbitrary attributes and aggregations; and support for remote access. The object management system generated by system 10 is flexible to allow rich modeling and access capabilities, and eliminates the need of writing boiler plate code.

In an embodiment the JAVA environment is used to implement and extend the system 10. The JAVA environment is used as an illustration, any other OOE providing necessary OOP features including reflection can also be used. The object oriented JAVA environment provides a convenient way to implement the system 10. In particular, the system 10 utilizes the reflection mechanism provided by the ‘java.lang.reflect’ package. The package ‘java.lang.reflect’ provides classes and interfaces for obtaining reflective information about classes and objects.

The source templates 12 contain source code and pragmas prefixed with the ‘::’ symbol. The source templates 12 also contains pre-described patterns having three types of relationships: scalar references, strong aggregate relationships and weak aggregate relationships. The source templates 12 also include constructors for the scalar references, strong aggregate relationships and weak aggregate relationships. These three types of relationships relate the objects which descend from a common standard base class. The source templates 12 can also contain normal source code for manipulating or retrieving the model objects in memory or in the database via custom SQL statements.

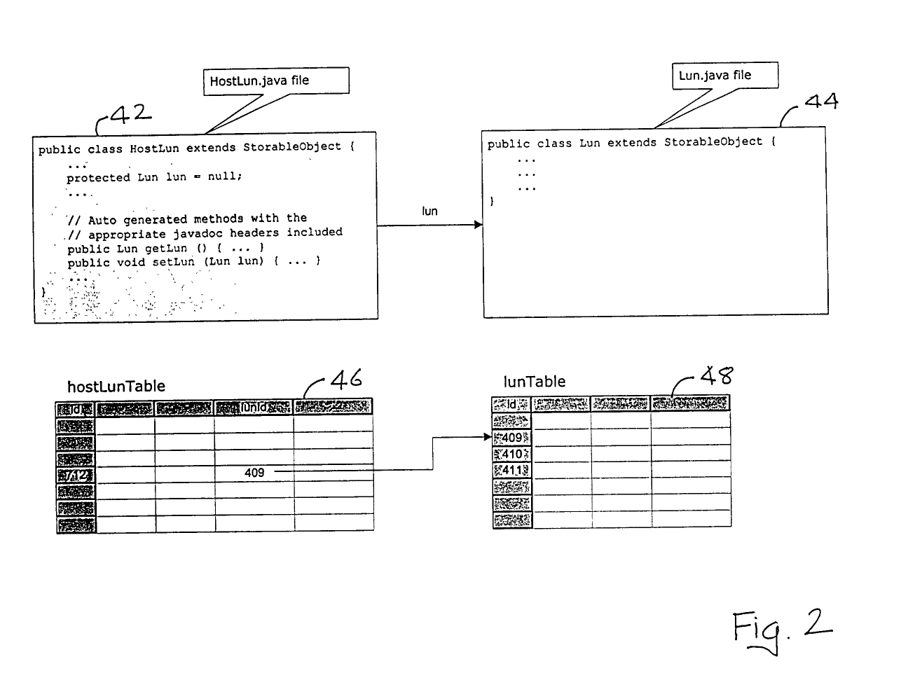

Referring to FIG. 2, the scalar reference relationship is illustrated with an example. Here, a class named ‘HostLun’ has a scalar reference relationship with the another class called ‘Lun’. The scalar reference is characterized by an one-to-one relationship. In this illustration, one ‘HostLun’ object is related to another one ‘Lun’ object. The HostLun.java snippet 42 and Lun.java snippet 44 show that both the classes ‘HostLun’ and ‘Lun’ descend from the same standard base class ,i.e., ‘StorableObject’. The HostLun.java snippet 42 shows that the methods for handling the ‘Lun’ object are generated automatically by the system. This relationship information is stored in the fields of a SQL tables. A hostLun table 46 stores the class members of an instance of the HostLun class in a single row, and stores an additional link referring to the related Lun object stored in a lunTable 48. For example, a HostLun object (having an ‘id’ field value of 712) is shown as stored in hostlun table 46, and has a link (stored as the field ‘lunId’ with a value 409) to an object in the lun table 48.

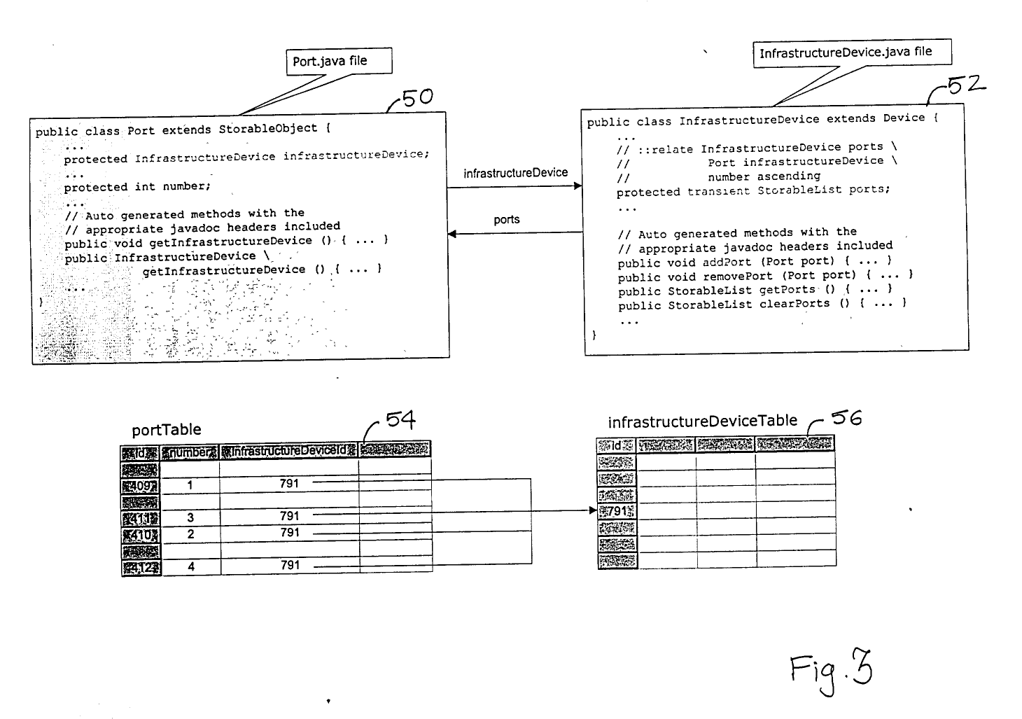

Referring to FIG. 3, the strong aggregate relationship is illustrated with an example. The strong aggregate relationship is typically a one-to-many relationship for modeling a parent-child relationship. An exemplary pragma for strong aggregate type of relationships is preferably specified in the following form:

::relate parentClass parentChildAggregationField childClass childParentReferenceField [sortfield [sortOrder] [singularName]]

In this illustration, a single ‘infrastructure device’ is related to multiple ‘ports’. The port.java snippet 50 and the InfrastructureDevice.java snippet 52 show a section of automatically generated JAVA code. The InfrastructureDevice.java snippet 52 also illustrates the ‘::relate’ pragma which links the list of ports in that class to the infrastructure device field in the port class. The port table 54 links multiple ports (having field ‘id’ values as 409, 411, 410, and 412) to a single infrastructure device in the infrastructureDevice table 56 (having field id value of 791).

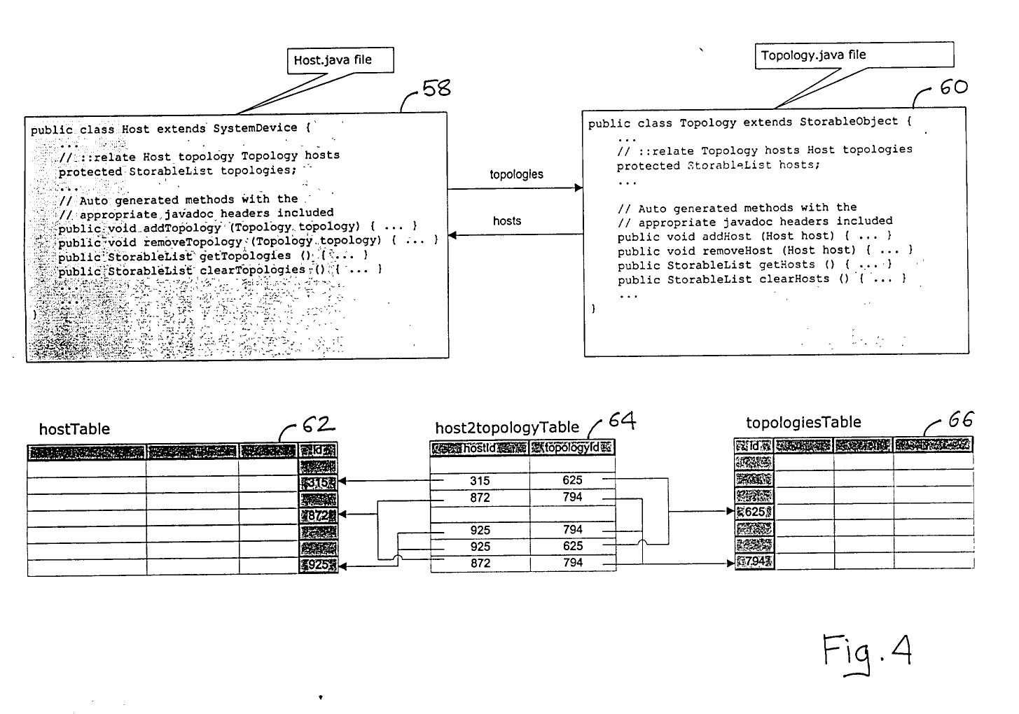

Referring to FIG. 4, the weak aggregate relationship is illustrated with an example. Here, host.java snippet 58 and topology.java snippet 60 both include ‘::relate’ pragmas. The host2topology table 64 stores the many-to-many relationship linking entries in the host table 62 and the topologies table 66. For example, a host having id value 315 is related to a topology having id value of 625 which in turn is also related to a host having id value of 925.

Weak aggregate relationships model many-to-many relationships. Weak aggregate relationships are of two types (not shown); asymmetric and symmetric. In the asymmetric weak aggregate relationship, the related objects are not updated simultaneously. But in the symmetric weak aggregate relationship, all objects that constitute the relationship are updated simultaneously.

A comparison of symmetric and asymmetric types of weak aggregate relationships is illustrated next for a weak aggregate relationship between the host table 62 and the topologies table 66. For example, in an asymmetric weak aggregate relationship any additions to the host table 62 are not automatically known to the object(s) representing the topologies table 66. Contrastingly, in a symmetric weak aggregate relationship, any addition to the host table 62 are automatically reflected in the object representing the topologies table 66. Thus, there is a mechanism for synchronously updating objects in the symmetric weak aggregate relationships unlike the asymmetric type. Symmetric weak aggregate relationships provide enhanced metadata about the objects in the relationship.

Implementing symmetric weak aggregate relationships requires additional code generation for supporting synchronous updating of constituents. At runtime, additional code in the form of special methods provides symmetric and synchronized updates to all constituents objects of a symmetric weak aggregate relationship. Symmetric weak aggregate relationship also require the schema generator to provide enhanced metadata.

An exemplary pragma for weak aggregate type of relationships is preferably specified in the following form:

::relate object1Class object1AggregationField object2class object2Aggregation Field [sortField [sortDirection] [singularName]]

The weak aggregate relationship is useful for situations where the classes are created without any predefined relationships, but are linked at a later point of time. The mapping of objects in the weak aggregate relationship is possible only at build time. As the type of objects in a weak or strong aggregate relationship is not known through reflection, which only reveals the type of the collection that represents the relationship, the programmer can specify that additional type information through the use of ::relate pragma.

Pragmas are directives to control the compilers or pre-compilers and control the manner of code processing. The invention is not limited by the type or format of pragmas used. Those skilled in the art will appreciate that a variety of pragmas can be used in place of or in addition to those discussed here. For example the following table lists illustrative pragmas and their descriptions:

| Pragma Format | Description |
|---|---|
| ::post-compile | Any line containing this pragma will |
| | be deleted prior to the second pass. |
| | This is used for commenting out |
| | manually generated code in |
| | constructors and/or custom model |
| | methods, which depend on auto- |
| | generated methods which have not |
| | yet been generated prior to the |
| | second pass. |
| ::relate <parentClass> | Describes a strong aggregate |
| <childCollection Field>\ | relationship among the parent and |
| <childClass><parentReference | child objects. For strong aggregate |
| Field> \ | relationships, i.e., ones where the |
| [childFieldToSortOn>[ascending \| | relationship is maintained via a scalar |
| descending]] | reference field in the child class to |
| | the parent, this collection does not |
| | need to be stored hence the member |
| | should be marked as transient. |
| | Appropriate secondary index will be |
| | generated in SQL schema and a set |
| | of JAVA collection access methods |
| | will be generated during build time as |
| | a result of this pragma. |
| ::relate <objectClass1> | Describes a weak aggregate |
| <collectionField><objectClass2> | relationship, i.e., one where the |
| null | relationships can come and go |
| | without the objects being destroyed. |
| | This collection must not be marked |
| | transient. Appropriate relationship |
| | table will be generated in the SQL |
| | schema and a set of JAVA collection |
| | access methods will be generated |
| | during build time as a result of this |
| | pragma |
| ::include <file><searchToken> | Allows a file (presumably containing |
| <replacementToken> | patterned code) to be inlined into the |
| | JAVA template file prior to first pass |
| | compilation. The inclusion process |
| | can be accompanied by a crude |
| | pattern substitution process. |

A pragma can include an optional singular field. Programmer can define the singular field to control the naming of methods. The standard JAVA naming of methods may not properly capitalize abbreviations. The optional singular field will allow proper capitalization of abbreviations.

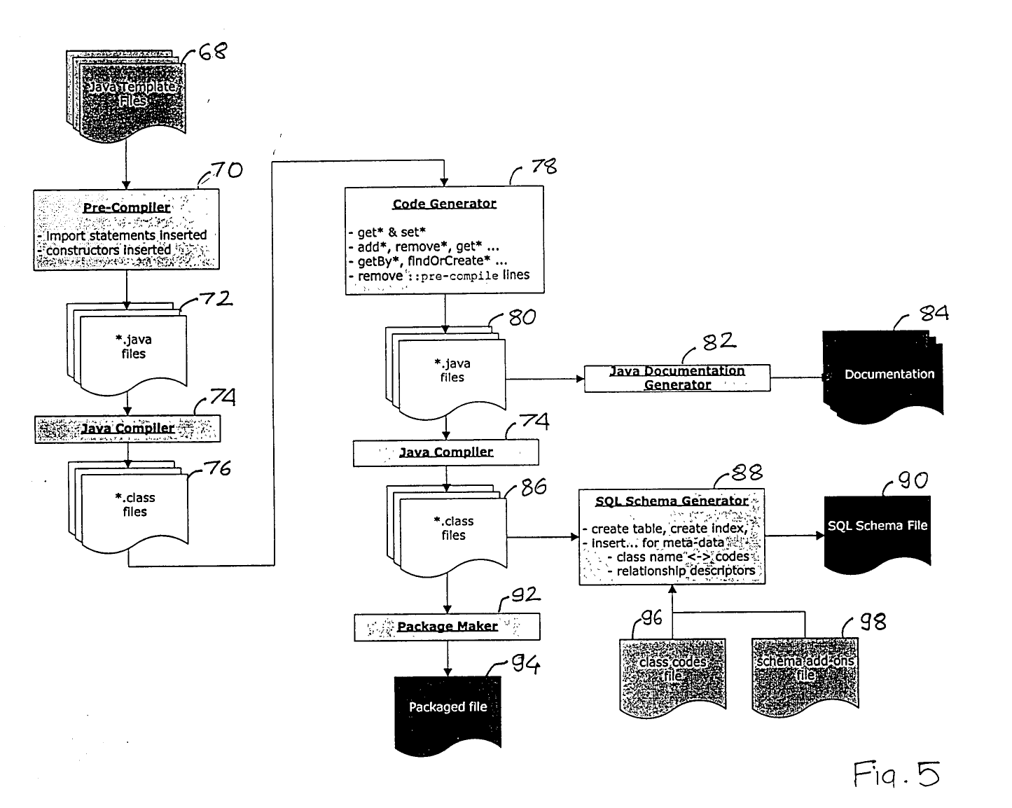

Referring to FIG. 5, in the embodiment under discussion the pre-compiler 70 reads and pre-compiles the JAVA template files 68 to generate the pre-compiled JAVA files 72. The pre-compiler 70 inserts the required ‘import’ statements and default constructors. The pre-compiler 70 processes all ‘::include’ pragmas by inlining the pragma specified files. A JAVA compiler 74 compiles the pre-compiled JAVA files 72 to output the first class files 76. The JAVA compiler 74 can be ‘javac’ or any other suitable JAVA compiler. The code generator 78 analyzes the class files 76 and performs reflection on the first class files 76. The code generator 78 also automatically adds the required supporting methods to the code, and the code to perform runtime SQL statement generation. For example, the ‘get’ and ‘set’ methods are added for all scalar fields using reflection; ‘add’, ‘remove’, ‘get’ and other methods are generated for all aggregations using reflection and hints from ‘::relate’ pragmas; ‘getWhere’, ‘getBy’ and ‘findOrCreate’ methods are generated on the basis of pragmas. Additionally, the code generator 78 removes the no longer necessary ::pre-compile pragmas in the code. Thereafter, the code generator 78 generates JAVA source files 80.

The invention provides storable iterators for traversing collection of objects. The storable iterators provide significant improvements over the standard JAVA iterators for traversing a set of objects. Storable iterators provide method over and above the standard JAVA iterators. For example, storable iterator provides methods going backwards and set the cursor at a specific location in the database like the beginning or the end. The invention gives the programmer the ability to use the storable iterators or JAVA iterators in tandem and as required. The operation of storable iterators is described next.

Storable iterators are used in the present invention to traverse a collection of objects. Storable iterator provides a ‘next’ method to access the next object in collection of objects, where the objects represent the fields in the database. Storable iterator does not load all data from the database into the objects, but access the database in a just-in-time manner. When the next method of storable iterator is called, the next method fetches only the data for the next object in the collection from the database. Code generation phase creates new code that provided ability to load data from the repository/database via storable iterators. For each method generated to load data in batches, there are two methods generated to load data via storable iterators—one in natural unsorted manner and one in an ordered manner, for example, as sorted by the key an order direction specified by the caller of the method.

Storable iterators takes benefit of storable cursors facility provided by modern database management systems. Storable iterators when used with storable cursors reduces the size of synchronization blocks. Without storable iterators large synchronization blocks of code are required to lock the database while the iterator is traversing through the data-sets built from the database contents. With storable iterators synchronization block is much smaller in size and operation time, because the database needs to be locked only for a small time window required for executing the next method. This small time window requirements is further optimized by storable cursors, which provide optimized access to the database.

A JAVA documentation generator 82 processes the JAVA source files 80 to generate the documentation 84, which contains the application programming interface (API) documentation. The JAVA documentation generator 82 can be the ‘javadoc’ tool or any other suitable documentation tool. The JAVA source files 80 are read and compiled by the JAVA compiler 74 to produce second class files 86.

A SQL schema generator 88 analyzes the second class files 86 to generate a SQL schema definition 90. In another embodiment the system user can add schema add-ons 98 to customize the SQL schema and class definitions. In yet another embodiment a package maker 92 packages the second class files 86 into a packaged file 94. The class code catalogue 96, provided by the model developer is stored in a static meta-data table and serves the purpose of mapping the code, and is an integer number to the name of the model object class and vice-versa. This code is then inserted into the specified bit-range of the internal unique identifier of each object. Therefore the internal unique identifier essentially embeds the type of the object and is therefore completely self-contained. The unique identifier not only specifies which row corresponds to the object, but also which database table the row is located in, i.e., what the class of the object is.

The schema generator 88 also utilizes a custom driver (not shown). The custom driver provides transparent access to the database management system (DBMS) specific features. Scheme generator 88 can use the custom driver to optimize and fine-tune the generated schema for a given target DBMS. For example, the custom driver can take benefit of SQL extensions provided by a specific database vendor. Hence, the custom driver provides additional control over the schema generation process.

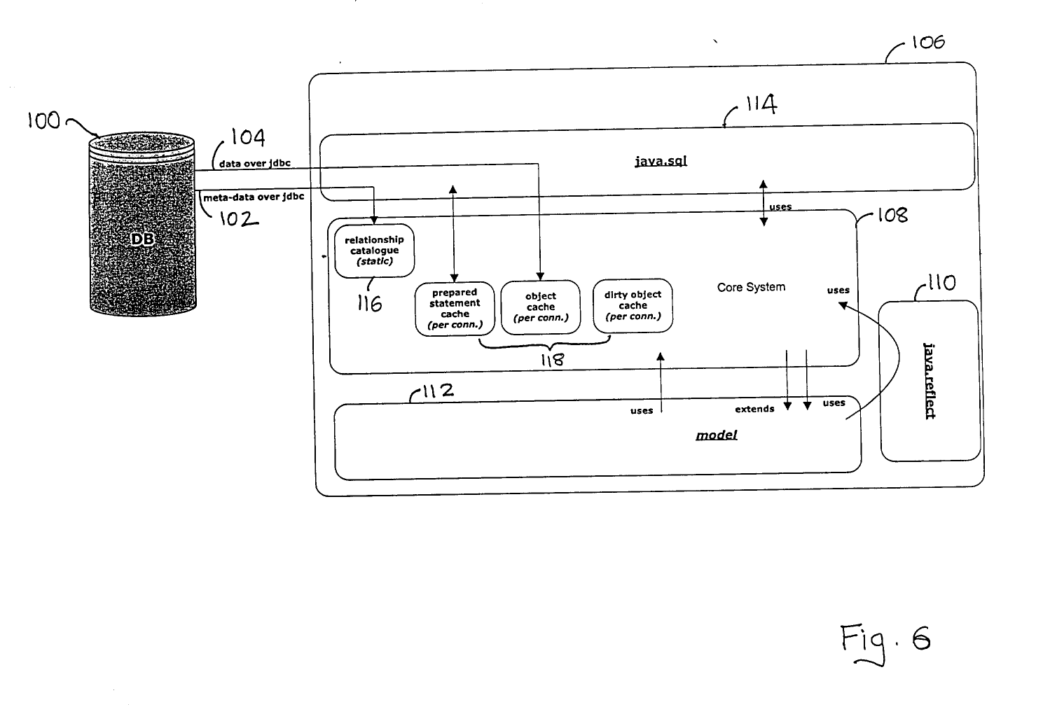

Referring to FIG. 6, a database 100 is used to store the objects. Database 100 communicates using JDBC (Java DataBase Connectivity) links with an application 106. The invention is not limited by the type of database connectivity or the specific underlying database. Those skilled in the art would appreciate that apart from JDBC other database connectivity mechanism can also be used to communicate with the database. So also, apart from relational database other data storage and organizing mechanisms can also be used. For example, the data may be stored in XML (extended Markup Language) format. A data link 104 is used to transfer data and metadata link 102 is used to transfer metadata. The application 106 consists of a core system 108, java.reflect package 110, model 112 and java.sql package 114. The core system 108 performs the tasks of storing and retrieving objects from the database 100. The core system 108 is domain independent and generic. The core system 108's concern is: ‘how to store?’. The core system 108 handles the JDBC interaction and also uses JAVA reflection mechanism. The model 112 is domain dependent and storage specific. The model 112's concern is: ‘what to store?’. This requires contributions from domain experts who need not have knowledge of JDBC. The core system 108 uses a custom driver (not shown) for interacting with the database. The custom driver provides the core system 108 access to database system specific features.

Model 112 invokes, operates and terminates storable iterators (not shown) for traversing collection of objects.

The model 112 extends and uses the core system 108. The core system 108 interacts with a java.sql package 114. Both the model 112 and the core system 108 interact with a java.reflect package 110. The core system 108 maintains a static relationship catalogue 116 containing metadata about the relationships for the relevant objects stored in the database. For example the relationship catalogue preferably contains description of strong relationships in the following form:

parentClass parentChildAggregationField childClass childParentReferenceField [sortField [sortOrder]]

While, the relationship catalogue preferably contains description of weak relationships in the following form:

objectClass object1AggregationField object2class object2AggregationField

In an embodiment the core system 108 includes caches 118 for prepared statements, objects, and dirty objects. The code for the methods of the standard base class, i.e., ‘StorableObject’ generate, prepare, cache, and use SQL statements. The table below lists examples of methods and the corresponding SQL statements:

| | |
|---|---|
| .store( ) | insert into classTable ... pr update c;assTable..where |
| | id=? |
| .load( ) | select ...from classTable where id=? |
| .loadall( ) | select...from classTable |
| .delete( ) | delete from classTable where id=? |
| .loadChildren( ) | select...from childClassTable where parented = ? |
| .getClassByField(...) | select...from classTable where field=? |

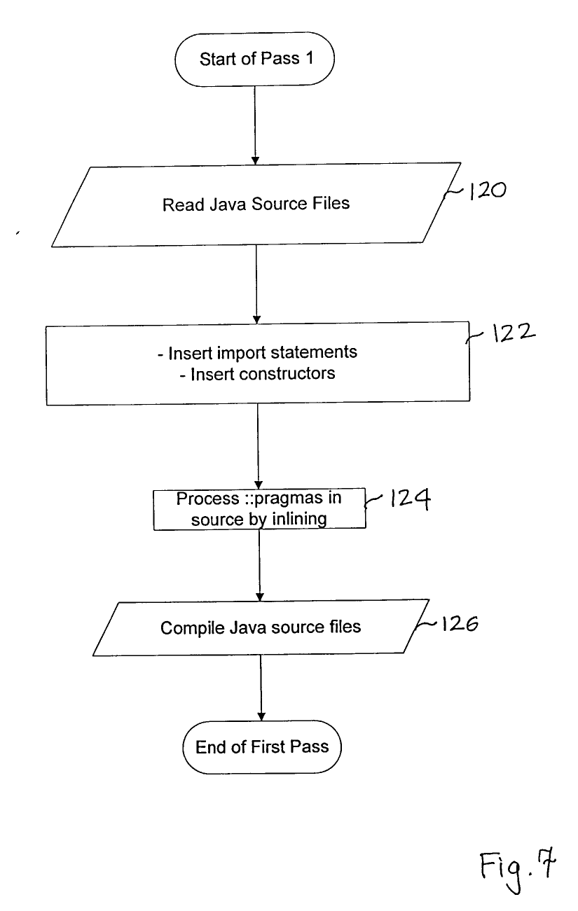

Referring to FIG. 7, in one of the methods of the invention during the first pass in step 120 the source template files are read. In step 122 the read template files are pre-compiled by inserting import statements and constructors. Thereafter, in step 124 pragmas are processed. The modified template files are compiled in step 126.

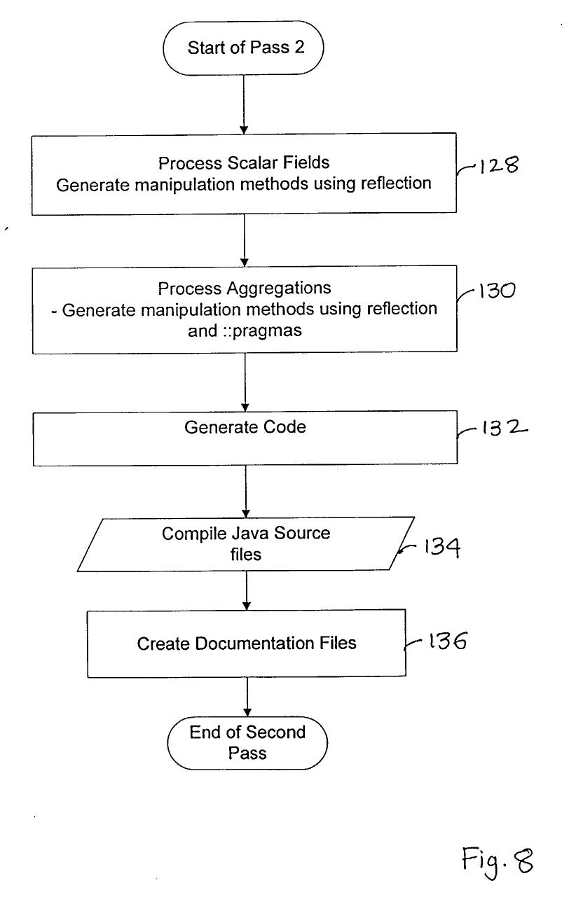

Referring to FIG. 8, in the second pass the scalar fields are processed and associated manipulation methods are generated using reflection as shown in step 128. Further, in step 130 the aggregations are processed and associated manipulation methods are generated using reflection and certain ::pragmas. Code is generated in step 132 and compiled in step 134. Documentation is created in step 136.

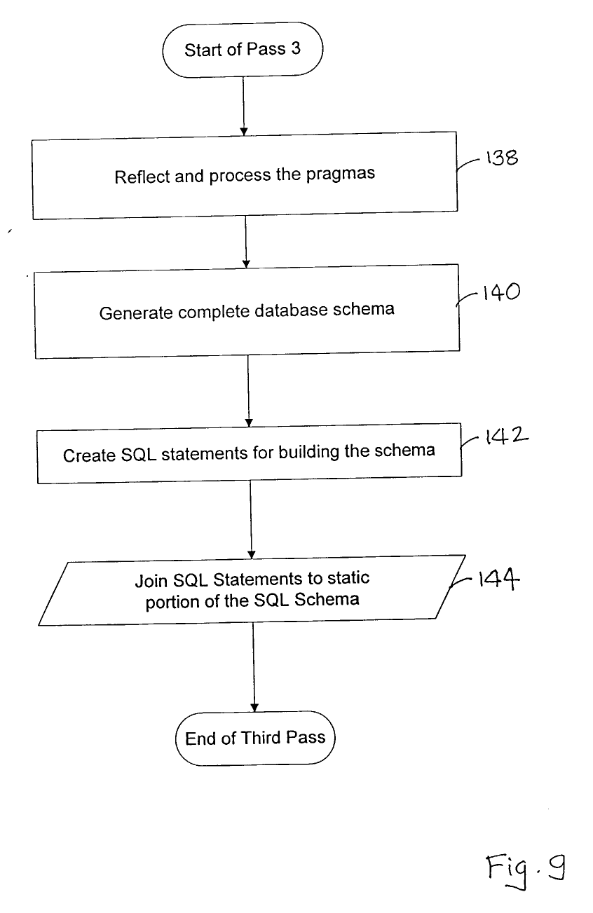

Referring to FIG. 9, in the third pass reflection is performed and pragmas are further processed in step 138. In step 140 complete database schema is generated. This is followed by creation of SQL statements for building the schema as shown in step 142. Finally, in step 144 the generated SQL statements are joined to the static SQL schema.

Reflection, i.e., introspection is used throughout the process of schema generation, code generation and even at the runtime. To improve the performance of reflection, an introspection cache (not shown) is utilized. The cache follows a lazy caching paradigm and caches the result of an introspection. Hence, a repeat call for an introspection of a given object is serviced by the cache. Without such a cache, an introspection/reflection call performs introspection of the whole class hierarchy of a given class. Reflection cache is used by the system to perform its internal functions like code generation, schema generation and generating database commands at the runtime. Reflection cache is also implemented in the generated code for the application to use it during its runtime.

The invention is not limited to the above described three-pass processing. Those skilled in the art will appreciate that the invention is broad enough to be embodied in different types of code processing including a single pass processing system.

The description of the invention is merely exemplary in nature and, thus, variations that do not depart from the gist of the invention are intended to be within the scope of the invention. Such variations are not to be regarded as a departure from the spirit and scope of the invention.

The code libraries which provide the code-generation capability during build-time also serve as the foundation for generating SQL commands at run-time. The structure of an object is determined via reflection mechanism and that information is used to construct properly structured SQL queries and update statements, used to do the following:

Store individual objects and their relationships with other objects; either via insert or update SQL statement depending on whether the object has been previously stored.

Load individual objects and their relationships with other objects.

Load a collection of objects of the same class; all objects or only objects whose named field have a specific value.

To gain efficiency at run-time, the string form of the SQL commands is generated on demand and the prepared statements are then themselves cached for later use. To save memory, the statement cache itself is periodically pruned of entries which have not been used in a prescribed amount of time. Therefore, only popular statements will remain cached, while the others that are not needed as often will not occupy memory resources. The caching helps by first eliminating the need to repeatedly use reflection and time spent on construction for the SQL commands in their string form and secondly, by allowing use of SQL prepared statement concept which is inherently more efficient when used repeatedly.

What is claimed is:

1. A database command generator for a persistent object management system, comprising:
a database;
an application implementing the persistent object management system, said application including a core system and a model for manipulating a plurality of member variable objects residing on said database;
said application operating in a runtime phase;
said model interacting with said core system using a reflection mechanism; and
said core system interacting with a database manipulation mechanism for generating a plurality of database commands.

2. The system of claim 1 further comprising:
at least one storable iterator for traversing a collection of objects at runtime, said model invoking, operating and terminating said storable iterator.

3. The system of claim 1 further comprising:
a reflection cache accessed by said model for interacting with said core system for using said reflection mechanism, said reflection cache providing accelerated access to said reflection mechanism by caching the results of said reflection mechanism.

4. The system of claim 1 further comprising:
a custom driver used by said core system for interacting with said database manipulation mechanism for generating a plurality of database commands.

5. The system of claim 1 wherein said database manipulation mechanism is a SQL (Structured Query Language) mechanism and said database commands are SQL statements.

6. The system of claim 1 wherein said reflection mechanism is a JAVA reflection mechanism.

7. The system of claim 1 wherein said member variable objects are chosen from a group consisting of scalar references, strong aggregate relationships, symmetric weak aggregate relationships and symmetric weak aggregate relationships.

8. The system of claim 1 wherein said model providing synchronous updating for said members variable objects of said symmetric weak aggregate relationships type.

9. A database command generator for a persistent object management system, comprising:
a database having a meta-data link and a data link;
an application implementing the persistent object management system, said application including a core system and a model for manipulating a plurality of member variable objects residing on said database;
said application operating in a runtime phase;
said core system including a relationship catalogue;
said data link connecting said application with said database;
said meta-data link connecting said database with said relationship catalogue;
said model interacting with said core system using a reflection mechanism; and
said core system interacting with a database manipulation mechanism for generating a plurality of database commands.

10. The system of claim 9 further comprising:
a plurality of object caches included in said core system;
said object cache communicating with said database over said data link;
a prepared statement cache communicating with said database manipulation mechanism; and
a dirty object cache communicating with said model.

11. The system of claim 9 wherein said database manipulation mechanism is a SQL (Structured Query Language) mechanism and said database commands are SQL statements.

12. The system of claim 9 wherein said reflection mechanism is a JAVA reflection mechanism.

13. The system of claim 9 wherein said member variable objects are chosen from a group consisting of scalar references, strong aggregate relationships, and weak aggregate relationships.

14. A method for generating database commands at runtime, comprising:
implementing a model extending a core system in an application;
reflecting into said core system by using a reflection mechanism;
communicating data from a database to said core system over a data- link;
communicating meta-data from said database to a relationship catalogue included in said core system; and
generating a plurality of database commands.

15. The method of claim 14 wherein said database commands are SQL (structured query language) statements.

16. The method of claim 14 further comprising the steps of:
calling a SQL engine by said core system.

17. The method of claim 14 wherein said reflection mechanism is a JAVA reflection mechanism.
